(19) United States
(12) Patent Application Publication
(10) Pub. No.: US 2006/0152595 A1
(43) Pub. Date: Jul. 13, 2006

(54) Method for capturing of real-time image

(76) Inventors: Jung-Hee Ryu, Seoul (KR); Dong-Jin Kwon, Gyeonggi-do (KR)

Correspondence Address: Shinjyu Global IP Counselors, Suite 700, 1233 Twentieth Street NW, Washington, DC, 20036, US

(21) Appl. No.: 10/529,884

(22) PCT Filed: Feb. 27, 2004
(86) PCT No.: PCT/KR04/00431

§ 371 Date: Apr. 1, 2005

(30) Foreign Application Priority Data
Apr. 7, 2003 (KR) 10-2003=0021699

(51) Int. Cl. H04N 5/225

(52) U.S. Cl. 348/220.1

(57) ABSTRACT

The present invention discloses services for allowing a user terminal to capture a code image recorded in a variety of on-line/off-line media in real time, to decode a code value, and to receive desired information based on the code value. A method for capturing a still image in real time according to an embodiment of the present invention includes the steps of: allowing an image capture means to pause a preview; copying the image paused through the pause step to a storage unit of a system; and re-executing the preview before a process of processing the stored image begins after the still image is stored.

### TECHNICAL FIELD

The present invention relates to a method for allowing a user terminal to capture an image recorded in various media in real time. More particularly, the present invention relates to services wherein a user terminal captures a code image recorded in various on-line/off-line media in real time to decode a code value and obtains desired information using the decoded code value.

### BACKGROUND ART

Recently, multimedia is used in various portable terminals or systems. A variety of contents are provided and utility services are activated, using multimedia. In particular, the function of picking up and editing a motion picture become versatile in most home appliances along with the spread of a digital camera and a camcorder.

In an existing still image decoding system, in the event that an image is captured in real time, a still image capture using the snap shot is used. That is, in the case where a motion picture is captured, the image is captured in a compressed JPEG format, which results in a reduction in the data transfer rate. If it is desired to store the still image in real time, an image of one frame is stored approximately every 1/15 seconds. Thus, there occurs a problem in that the image is broken. Further, when capturing the image in real time, a user feels inconvenient due to a reduced sensible rate.

A process of capturing a still image and processing the image using it in the related art will now be described in detail with reference to FIG. 9.

A method for capturing a pause image of one cutting in a portable terminal having an image capture means such as a CCD camera is as follows.

A preview screen is executed on a viewfinder and a user then confirms the preview screen while viewing the viewfinder (S901).

If the user catches a desired object while executing the preview screen (S903), the user captures a sheet of a snap shot using a pickup input button, etc. provided in the device. In the above, the term snap shot refers to an instant pickup of a moving object or its picture as a dictionary meaning. In other words, in order to capture a still image, the user executes the preview screen on the viewfinder, catches the desired object and then depresses the pickup input button, so that a pause image of one cutting is instantly obtained from the preview screen.

The image captured as the snap shot as described above is usually stored in a memory of the user terminal in a compression format such as JPEG (S907).

As such, steps from step (S901) to step (S907) belong to a conventional method (S900) for capturing the still image.

The image data, which is compressed/stored through the method for capturing the still image (S900), is secondarily utilized in the user terminal through a subsequent image processing process (S910). Secondary utilization means that in case of a barcode image, information written in barcode is decoded and is then connected to a corresponding application, and that it can be used as remodeling and decoration of the still image through the preview image. Such an image processing process will be described as follows.

An image data that is compressed/stored in the JPEG format, etc. is decompressed (S911).

A snap shot being the decompressed image data is analyzed (S913) and is decoded.

If the snap shot is successfully decoded (S915), a corresponding result value is returned, thereby completing the image processing process (S917).

However, if the snap shot is unsuccessfully decoded (S915), the process returns to the step of executing the preview (S901) for obtaining a new snap shot.

In reality, an image data to be decoded has to be captured to a degree that a snap corresponding to an image at the time when the image is picked up is decodable. Accordingly, there may be a case where a user is unskilled in using the device or obtains a still image improper for the decoding due to other factors. That is, the probability that a good and desired snap shot can be obtained at a time, is very low. Therefore, there is a difficulty in that the user has to return to the pickup mode several times until the decoding is successful, and then repeats the process of capturing the still image. In this case, there occurs a problem in that re-execution of a preview for other purpose is impossible until the image is successfully processed.

Furthermore, there occurs still a problem in that normal re-execution of the preview screen is impossible until the image processing process is successfully performed. This is because a paused preview image, which remains in a LCD buffer region, etc., is employed in an image-processing module upon pause of the preview. That is, there occurs a problem in that updating of a new preview image is hindered before the image processing process is normally finished. In this case, as the user can do nothing while the image is being processed, which results in significant waste in terms of system utilization.

As described above, the method for capturing the still image in real time according to the prior art has problems that lots of time and efforts are required due to unskilled manipulation of a user terminal, execution of a preview screen is paused until the image processing process is finished, and the user continuously performs the process of capturing the snap shot until the image is normally processed.

An inventor of this application filed a patent (Korean Patent Application No. 2000-0085811, Dec. 29, 2000), which discloses the configuration of a pattern having code information, and a coded pattern wherein an image of the pattern is captured using a camera and a code is extracted from the image and code extraction method thereof. In this patent, barcode of a two-dimensional structure is captured by various devices each having a camera and a code is extracted from the barcode.

Furthermore, the inventor filed a patent (Korean Patent Registration No. 10-0323759), which discloses a device wherein a specific code is extracted from a pattern image using a mobile communication device having a camera, and information is displayed on the device according to the code or provided through a communication network, and method thereof.

Incidentally, the inventor filed a patent (Korean Patent Application No. 2000-0032164, Jun. 12, 2000), which discloses a method and system for providing information on an object, which contains an ID symbol that is physically readable. In the method and system, a virtual space is searched for information on an object existing in a real space, information on a predetermined product or the like through a network, and the search result is then provided to a user.

The aforementioned prior arts are intended to provide various information and related services over the entire real life by allowing a user terminal to capture a code image, whereas the present invention is intended to provide a method for allowing a user terminal and various systems to capture a code image and process the image in a more advanced manner.

### DISCLOSURE OF THE INVENTION

Accordingly, the present invention has been made in view of the above problems, and it is an object of the present invention to provide a method for capturing and processing a still image in real time using various image capture devices such as a CCD camera, a digital camera, etc. More particularly, an object of the present invention is to rapidly capture a still image from a preview image upon capture of the image, process the captured image and then apply the processed image to various applications.

To achieve the above objects, according to the present invention, there is provided a method for capturing a predetermined image frame in a system having an image capture means, including the steps of: allowing the image capture means to pause a preview; copying and storing the paused preview image; and after the still image is stored, re-executing the preview before the process of processing the stored image begins.

Furthermore, the method for capturing the still image in real time further includes the step of, if the image that is copied and stored in the step of storing the still image is a compressed format, decompressing the image after the step of re-executing the preview, wherein the image processing in the step of decompressing the image does not affect the re-execution of the preview.

Also, to achieve the above objects, there is provided a method for capturing a predetermined image frame in a system having an image capture means, including the steps of: inhibiting a write into an image buffer region of a image storage unit within the system; subjecting the image stored in the image buffer region to a Crop and Resize process to copy the processed image to other region of the image storage unit; and permitting a write into the image buffer region of the image storage unit, wherein in a state where an image preview is continuously activated, a real-time still image is captured by controllably activating and inactivating the write of the still image into the image buffer region.

Furthermore, there is provided a method for providing services using a code image, including: a code image capture step using the method for capturing the still image in real time according to the present invention; a decoding step of allowing an image processing unit to decode the code image captured through the code image capture step and to extract a code value;

a URL call step of allowing a browser of a system to call URL associated with the code value to a host server associated with the system; and a step of allowing the host server to search URL or contents corresponding to the code value, to send the searched result to the system, and then to receive related services from the system.

### BRIEF DESCRIPTION OF DRAWINGS

Further objects and advantages of the invention can be more fully understood from the following detailed description taken in conjunction with the accompanying drawings in which:

FIG. 1 is a flowchart of a general application using a preview image in a variety of applications using a camera;

FIG. 2 is a block diagram illustrating a system having an image capture means according to an embodiment of the present invention;

FIG. 3 is a block diagram illustrating a system having an image capture means according to another embodiment of the present invention;

FIG. 4 is a block diagram illustrating a system having an image capture means according to still another embodiment of the present invention;

FIG. 5 is a flowchart illustrating a method for capturing a still image according to an embodiment of the present invention;

FIG. 6 is a flowchart illustrating a method for capturing a still image according to another embodiment of the present invention;

FIG. 7 is a flowchart illustrating a method for capturing a still image according to still another embodiment of the present invention;

FIG. 8 is a flowchart illustrating a method for capturing a still image according to still another embodiment of the present invention; and

FIG. 9 is a flowchart illustrating a process of capturing and processing a still image in the related art.

### BEST MODE FOR CARRYING OUT THE INVENTION

The present invention will now be described in detail in connection with preferred embodiments with reference to the accompanying drawings.

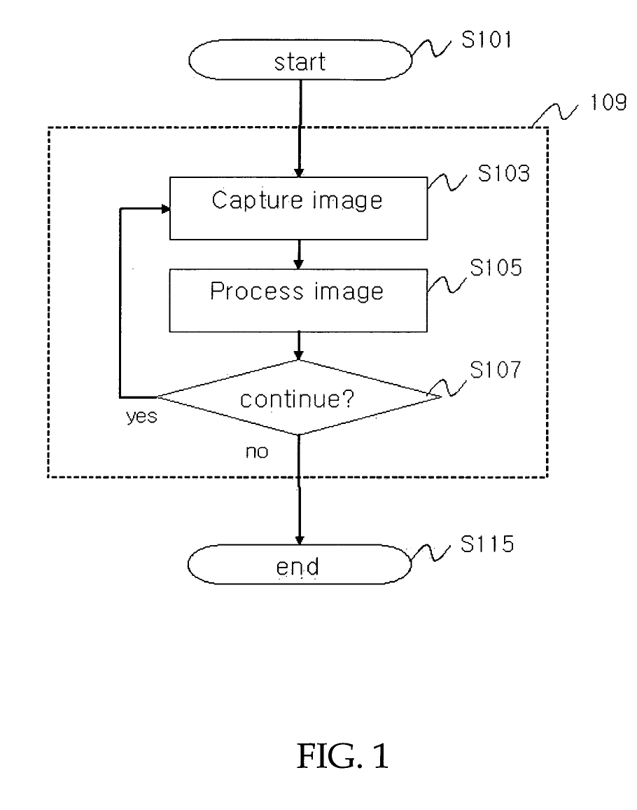

FIG. 1 is a flowchart illustrating a process of a general application using a preview image in various applications employing an image capture means such as a camera.

At the start step (S101) of the application, the application is initialized and the image capture means such as the camera is initialized. A method for executing an application loop 109 may include a simple repetition method based on an end condition search, as shown in FIG. 1, or a method using a timer in order to repeat tasks within an application loop. In case of the method using the timer, if a timer indicating an event that executes the application loop is called at the start step (S101) of the application, a timer event is generated in a predetermined time interval. Thus, in this method, the tasks are executed only once when the timer event is generated without repeating various initialization task steps (S103, S105 and S107) within the loop after searching the end condition search step (S107), unlike the simple repetition method based on the end condition search. Next, if the condition is satisfied in the end condition search step (S107), an end step (S115) is performed. That is, whenever the event is generated, the initialization tasks steps (S103, S105 and S107) are executed only once. If the end condition is satisfied in the end condition search step (S107), the process is finished and even if the end condition is not satisfied, the process does not repeat the loop.

If the initialization and the start are accomplished, an image is captured through the image capture means such as the camera (S103). In order to capture an image of one frame through the image capture means such as the camera with a preview image displayed, a variety of methods can be used. The present invention aims at the image capture process. A variety of methods are applicable to one system. Further, the present invention aims at an image capture method wherein the image can be selected more rapidly with an interval of some time left in bringing the image. Detailed description will be made in a corresponding portion with reference to corresponding drawings.

If the image is captured, the captured image is processed in an image processing unit according to a corresponding application (S105). The image is processed in a variety of formats according to a corresponding application. Examples of the application may include a code image recognition application, a motion picture encoding application, a character recognition application, applications such as image decoration and remodeling, and the like.

After the image processing step (S105) is finished, it is determined whether to repeat the application loop (S107). If the end condition is satisfied after searching the end condition of the loop 109, the application is finished (S115). If the end condition is not satisfied, the process returns to the image capture process (S103) and the loop is repeated until the condition is satisfied. In the event that a timer event is used in order to repeat the application loop, a corresponding timer is paused to finish repetitive tasks of the loop in the end step (S115).

The general application using the preview image shown in FIG. 1 includes the loop 109 wherein some of an application program are repeatedly performed until a predetermined number or a predetermined condition is satisfied when the programs is executed.

The loop 109 may be implemented by a method wherein an event procedure of an application receives the timer event, a method wherein the process exits the loop while continuously performing a “For” sentence, and the like. If the loop is implemented by the method wherein the event procedure of the application receives the timer event, a timer interval is sufficiently given considering a one-time execution time of the loop. If the loop is implemented by the method wherein the process exits the loop while continuously performing the “For” sentence, the loop can be implemented by giving some room to the system considering an adequate sleep time. In this case, the process of starting and ending the timer is not required.

If the application is finished (S115), the timer is first paused and the preview of the image capture means such as the camera is then paused. Further, if a memory is allocated in the initialization process, the process of releasing the memory may be performed.

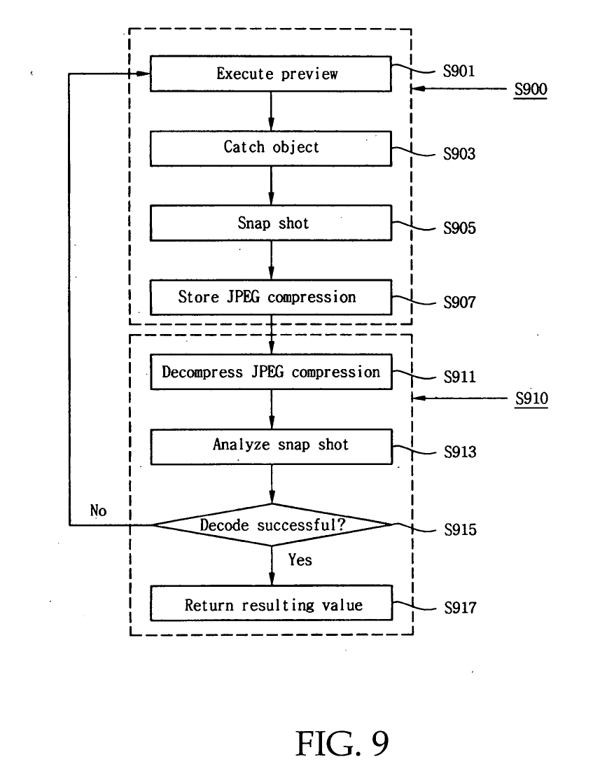

In the present invention, by using the above method, it is possible to repeatedly automatically perform the process of capturing the still image and processing the image until the decoding is successful within the device, without performing manual tasks such as additional pickup unlike the prior art described with reference to FIG. 9.

A system to which the application is usually applied, such as the user terminal having the camera, will now be described.

The system of the present invention has a means capable of capturing an image of a digital camera, a camcorder, a CCD camera, a photosensor, etc. and preferably refers to a portable wireless device such as a PCS, a cellular phone and an IMT 2000 device having a network transfer means, a notebook, a personal computer, a PDA, OCR and the like. That is, the system may include a variety of devices having an image capture means and an image processing means, and all the devices having a communication means. Digital image capture devices such as an existing digital camera and camcorder are also included in the system of the present invention. It is, however, to be noted that the system of the present invention is not limited to the aforementioned devices having the communication means.

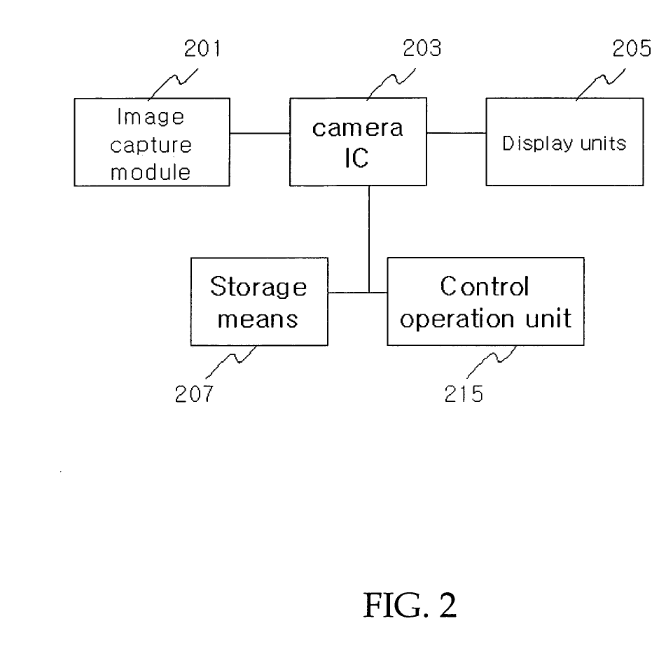

FIG. 2 is a block diagram illustrating the system having the image capture means according to an embodiment of the present invention.

The system shown in FIG. 2 is an example of a general system, which can capture a still image in real time. The system includes an image capture module 201 for capturing a variety of images from the outside, a camera IC 203 for processing the captured images outputted from the image capture module, a variety of display units 205 of an image output means such as a LCD, CRT and liquid crystal, a storage unit 207 for storing data such as an image therein, and a control operation unit 215 for controlling the system, wherein the control operation unit has various operations.

The system shown in FIG. 2 is an example of a system having a CPU whose performance is relatively low. In case of a CDMA or a GSM device using a CPU core of ARM7 series, an image is distributed processed in hardware in order to reduce the load of the CPU and the processed image is outputted to the display unit.

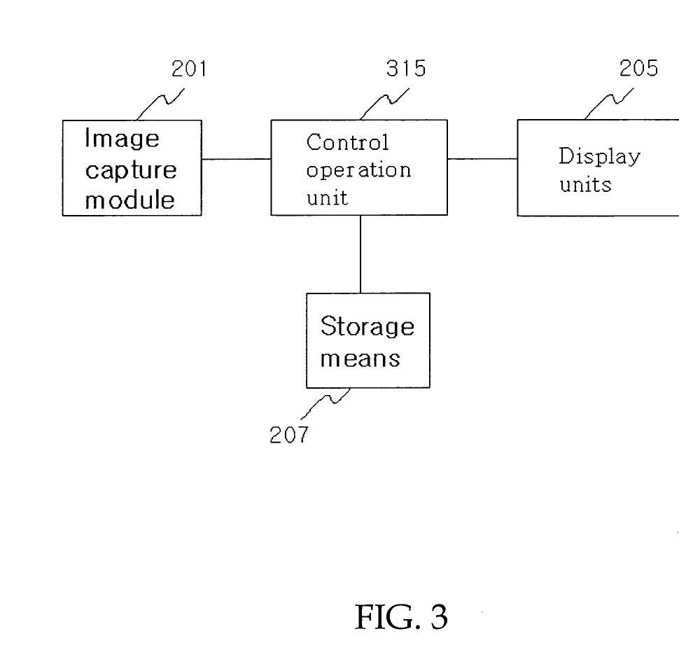

FIG. 3 is a block diagram illustrating the system having the image capture means according to another embodiment of the present invention.

The system shown in FIG. 3 is an example of a system having a CPU core of the ARM9 series whose performance is relatively high, unlike the system shown in FIG. 2. In this system, a control operation unit 315 directly controls the display unit 205. If the main function of the control operation unit 315 is an image processing, a system having another control operation unit that is connected to an interface of the control operation unit 315 is possible. In other words, as an example, a system in which the main function of the control operation unit 315 is an image processing and a modem chip is interfaced to the control operation unit 315, is possible. A representative one is 3G technology, which corresponds to a W-CDMA device having a camera, wherein W-CDMA employs CDMA instead of TDMA in order to increase a data transfer rate of the GSM system. The W-CDMA becomes a DS mode in 3G rules of ITU and includes 1× MC (multicast mode) and 3× MC.

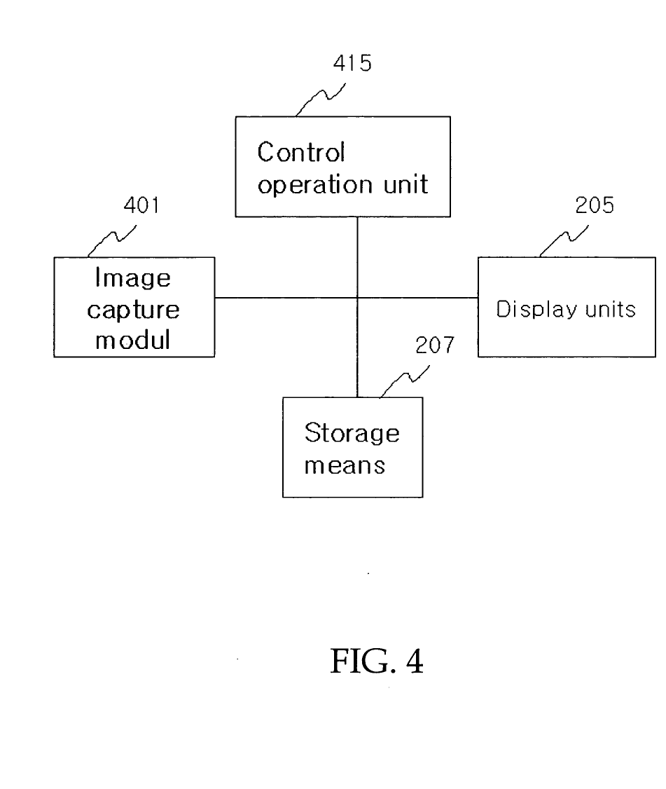

FIG. 4 is a block diagram illustrating the system having the image capture means according to still another embodiment of the present invention.

The system shown in FIG. 4 is an advanced system in which the relationship between a control operation unit 415, an image capture module 401, a display unit 205 and a storage unit 207 becomes more smooth compared with the systems shown in FIGS. 2 and 3. That is, the image capture module 401 can directly control the display unit 205, and the control operation unit 41 5 can control the image capture module 401 and the display unit 205. In this process, the storage unit 207 can be utilized in more free and various manner.

The method for capturing the still image in the systems in FIG. 2 to FIG. 4 will now be described in detail. That is, the image capture process (S103) among various application processes using the camera in FIG. 1 will be described with the accompanying drawings.

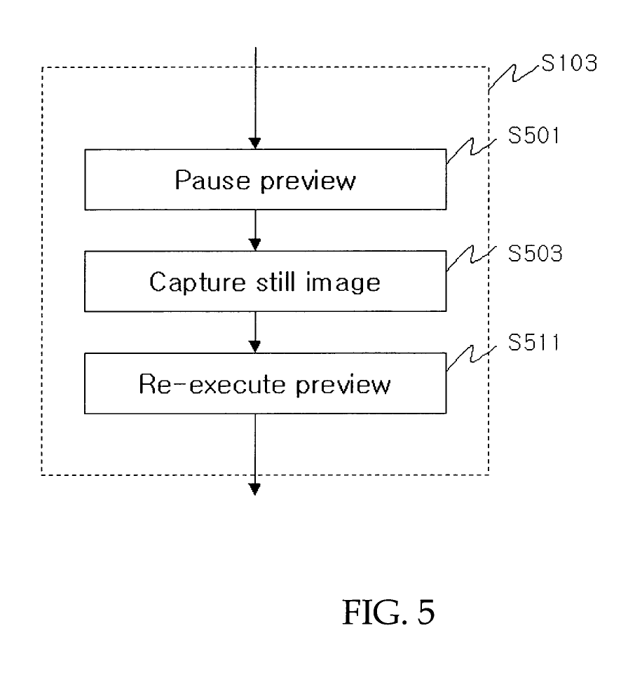

FIG. 5 is a flowchart illustrating a method for capturing a still image in real time according to an embodiment of the present invention.

An image capture means provided on a system pauses a preview (S501).

In the preview pause step (S501), in order for an image capture means such as a camera to capture a still image, a preview pause function, if any, is used, and a preview stop function is used if there is no the preview pause function.

The image paused in the preview pause step (S501) is moved to the storage unit of the system and a still image is captured from the image (S503).

In case where the image capture means such as the camera scatters a preview image on a display unit such as a LCD, if a camera preview is paused, a preview image remains in a LCD buffer region of the system. Therefore, if a range that the preview is scattered in the LCD buffer region is found, the review image can be obtained. Generally, the format of the images is the same as, for example, a LCD color representation mode of a RGB format, etc. and the resolution of the image is the same as the resolution of the preview displayed on the LCD. The above will be described in more detail. If the preview is paused, a preview image paused in the LCD buffer region remains. In the present invention, the preview image paused in the LCD buffer region is copied to other storage space on the system so that the image can be used in the image processing process. At this time, the reason why the still image for the image processing is copied to other storage space is that the image processing process does not affect execution of the preview. In the concrete, the storage space to and in which the preview image paused for the image processing is copied and stored may have only a different address on the memory where the original pause preview image exists. The preview image can be copied and stored in an additional storage space. This will be below described in more detail in a corresponding section.

After the still image capture step (S503), the preview is re-executed before the process of processing the captured image begins (S511). In the event that the preview is paused using the preview pause function, a preview resume function is executed. To re-execute the preview before the image processing process begins is for minimizing that a screen is broken or paused by first executing the preview since the routine of the subsequent image processing step (S105) is a time-consuming task that requires lots of time.

If the image is captured and data are transmitted by means of the method shown in FIG. 5, a data transfer rate can become rapid and the breakage or pause of a screen can be prevented compared with the prior art using the compressed image such as the JPEG format using the existing snap shot.

According to an embodiment of the present invention, the system having the image capture means is the system having the camera IC 203, which directly controls the display unit 205, as shown in FIG. 2. The region where the still image is captured/stored in the still image capture step (S503) is the storage unit 207 of the system, more particularly, a RAM, etc. connected to the control operation unit. The stored image has the same resolution as an image outputted from the display unit. That is, if the camera preview is paused (S501), an image at the moment when the preview image is paused remains in the image buffer region within the camera IC. It is thus possible to rapidly capture the preview image by reading that portion. Further, the paused preview image that is read from the image buffer region of the camera IC is copied and stored in the storage unit connected to the control operation unit 215. By utilizing such a newly stored image in the image processing, the preview can be normally executed without the effect from the image processing. Usually, the format of these images is the same as the color representation mode shown in the LCD and the resolution of the image is the same as the resolution of the preview displayed on the LCD. Accordingly, an output image recognized by the image capture means undergoes a Crop and Resize process by means of the camera IC and is then outputted on the display unit. In this embodiment, the cropped and resized image is brought.

In the above, the term Crop refers to a function of extracting some images from the entire image and the term Resize refers to a function of changing the size of the entire image.

According to another embodiment of the present invention, the system having the image capture means is the system in which the control operation unit 315 directly controls the display unit 205, as shown in FIG. 3. The output image of the image capture means such as the camera is stored in the storage unit 207 within the system. The output image of the camera, which is a stored original image, experiences the Crop & Resize process and is then copied to other region of the storage unit 207. Usually, the format of the image is the same as the Output format of the camera, etc. For example, the format may be a YUV format, etc. The YUV format is a format usually used in TV broadcasting and is conceived on the fact that the human eye is more sensitive to luminance than a color. In the above, Y indicates the luminance of a color and is sensitive to error. Thus, Y is coded at an upper bandwidth than color elements U and V. U and V refer to chroma. A typical Y:U:V ratio is 4:2:2, which is also used in CD-I and DVI.

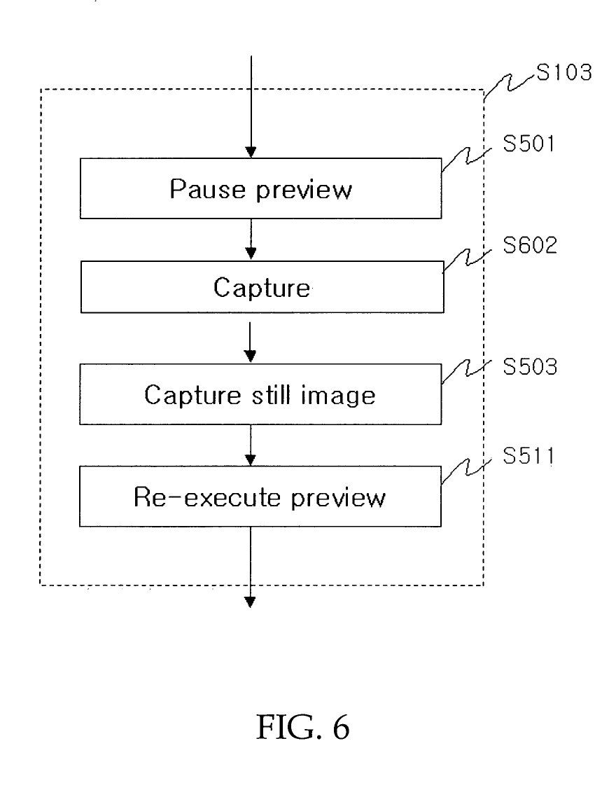

FIG. 6 is a flowchart illustrating the method for capturing the still image according to another embodiment of the present invention.

An embodiment shown in FIG. 6 corresponds to a method that is used when it is desired to capture an image of the resolution higher than a preview image.

An image capture means provided in a system pauses a preview (S501).

In the preview pause step (S501), like in the embodiment of FIG. 5 described above, an image capture means such as a camera uses a preview pause function, if any, and a preview stop function if there is no the preview pause function in order to obtain a still image.

In the event that an image of the resolution higher than a preview size is to obtain, a desired Crop and Resize condition is specified and a capture command is issued to the camera IC 203 (S602).

In this case, a corresponding captured image is stored in an image buffer region existing within the camera IC 203, etc. according to the specified Crop and Resize condition. The image stored in the image buffer region existing within the camera IC 203 is read through the preview pause step (S501) and the step of issuing the capture command (S602) and is then stored in the storage unit 207, so that the still image is captured (S503). A process such as a subsequent preview re-execution step (S511) is the same as that described above and will not be described further.

This embodiment corresponds to a method that can be used when an image of the resolution higher than a preview image is to be used, for example, such as when the output image of the image capture means is used intact.

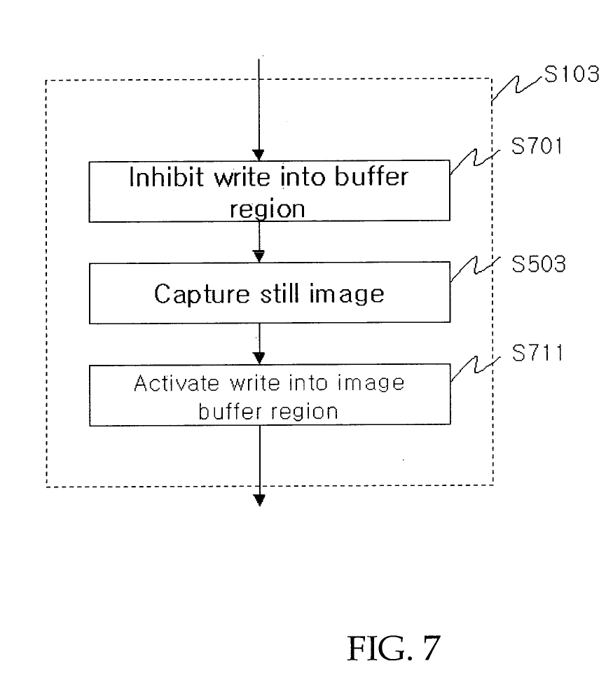

FIG. 7 is a flowchart illustrating the method for capturing the still image in real time according to still another embodiment of the present invention.

In this embodiment, in a state where the preview image is continuously received instead of the preview pause and re-execution steps in the aforementioned embodiment, a write of the image from an image capture module to a buffer region of a storage unit is inhibited and activated.

That is, this embodiment corresponds to a method wherein a preview is updated as times goes but an image buffer is not updated, and a still image is captured through control of write inhibition and activation.

The control operation unit of the system controls the system storage unit to inhibit a write into the image buffer region (701). At this time, the image stored in the image buffer region is subjected to the Crop and Resize process and is thus copied to other region of the system storage unit. The image copied to the other region is read to obtain the still image (S503).

After the image is copied to the other region, the control operation unit controls the system storage unit to activate a write into the image buffer region (S711).

In a state where the preview image is not paused and executed but is continuously received as above, the storage unit of the system is controlled to control write inhibition and activation of the image buffer region. It is thus possible to obtain a more rapid still image by comparing the preview image with the still image through the pause and execution.

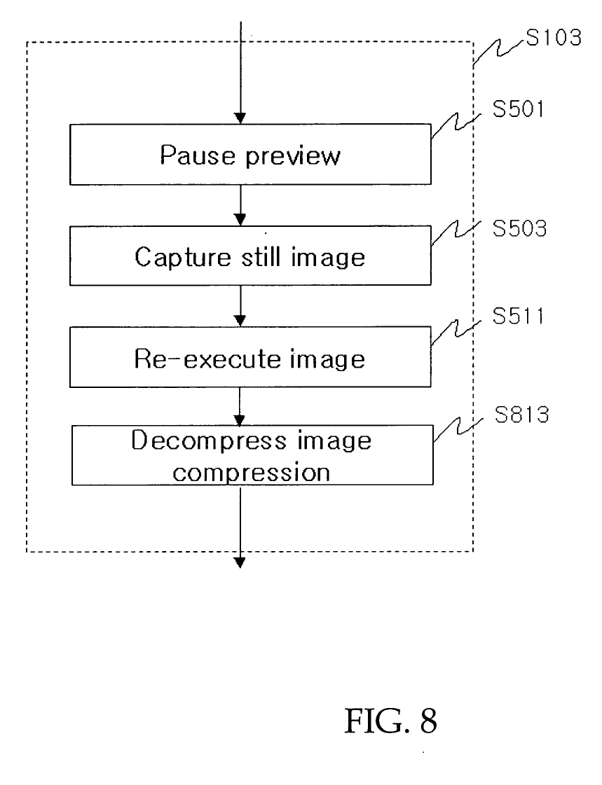

FIG. 8 is a flowchart illustrating the method for capturing the still image in real time according to still another embodiment of the present invention.

In this embodiment, if an image format that can be obtained from the camera IC, etc. is a compressed format such as JPEG, an image decompression step (S813) is further added to the image capture process described above.

### APPLICATION EXAMPLE

The process of capturing and processing an image related to an application will now be described.

Application Example Using Code Decoder

An application is initialized. At this time, a code decoder is initialized and a camera preview is started. A timer may be called and started, if needed.

After the initialization, the image capture unit properly performs the aforementioned still image capture process to capture a still image.

The image processing unit performs a decoding process to recognize the code by using the still image captured in the image capture unit as an input. The code image decoding process corresponds to the process of extracting a code value through the code image captured in the image capture unit. Such a code decoding process may be executed in a variety of methods depending on the format of the code image. If the code decoding fails, a new image is captured by the image capture unit. If the decoding is successful, the process exits the application loop to finish the code decoding.

After a code value is decoded through the code image, if the recognized code value is outputted to the decoder, a browser that supports the HTTP protocol such as a web browser, a WAP browser or a ME browser calls URL and URL is then executed.

The URL called through the browser has the following format.

[protocol name]://[host server name]/[switching software name]?[code value factor name]=[code value]

That is, for example, the URL may have the following format:
HTTP://sw.hot-code.com/sw.sap?code=12345678

In this case, other factors such as the type of a code may be additionally added to the URL.

In other words, for example, the URL may have the following format:
HTTP://sw.hot-code.com/sw.sap?code=12345678&type=EAN

If the code value is called as above, software of the host server searches a database for URL corresponding to the transmitted code value and then redirects the URL, or searches the database for contents to be connected and then generates a medium page connected thereto, so that the page can be viewed through a requester's browser.

Through the above method, a web, WAP, a ME page, a picture, background downloading, bell sound downloading, setting of connected communication sound, various virtual machine support applications such as a game, VOD, MOD, making a phone call, entry of personal information into an address book, editing of the address book, and other services can be provided to a user on a system browser.

2. Optical Character Recognition

OCR (Optical Character Recognition) refers to that letters, symbols, marks, etc. that are printed or hand-written into a paper are recognized by an optical means and are then converted into computer texts. The OCR scheme includes a pattern contrast method and a stroke analysis method. Recently, the use of a method such as hand-written character recognition has been increased. OCR may use a special read device, but may use a small-size optical scanner and dedicated software. In a character recognition application, like the code recognition application described above, after the application is initialized, a character image capture unit properly performs the still image capture process described above to capture a still image.

The image processing unit performs the character recognition process through a predetermined method such as the method described above by using the still image captured in the image capture unit as an input. If the character recognition process fails, the image capture unit captures a new image. If the character recognition process is successful, the image capture unit exits the application loop to finish the process.

3. Image Remodeling and Decoration

A user can remodel or decorate the still image captured with the digital camera, the camcorder, etc. using an appropriate tool.

That is, after the image is captured as described above, the image processing unit deforms and decorates the still image using image remodeling and decoration tools and then finishes the process.

The applications are only exemplary processes of capturing and processing the image related to the application of the present invention. The spirit of the present invention is not limited to the application examples. That is, the method of capturing the still image in real time according to the present invention is not limited to the application examples, but can be applied to a wide range of applications if they falls within the method for capturing the still image in real time according to the present invention.

### INDUSTRIAL APPLICABILITY

According to the present invention, a still image is captured in real time through an image capture means such as a CCD camera and a digital camera. More particularly, it is possible to capture and process a still image more rapidly using a preview image when the image is captured.

Therefore, the present invention allows a user to perform a code image decoding process more rapidly using the image capture method through a behavior that makes an image such as a code optically touch a camera and to receive services associated with a desired code more rapidly and conveniently. Furthermore, the present invention has an effect that it can be applied to various applications such as character recognition, real-time image remodeling and editing, etc.

What is claimed is:

1. A method for capturing a still image in real time in a system having an image capture means, a display unit, a storage unit and an image processing unit, wherein an external image captured by the image capture means is previewed on the display unit and a still image of a preview image is captured in real time in order to process the image, the method comprising the steps of:
pausing the preview outputted to the display unit through the image capture means;
copying and storing the image paused through the stop step; and
re-executing the preview before the process of processing the stored image begins.

2. The method as claimed in claim 1, wherein the image, which is copied and stored in the step of storing the still image, is stored in the storage unit connected to the image processing unit of the system and has the same resolution as that of the image outputted from the display unit.

3. The method as claimed in claim 1, further comprising the step of, if the image that is copied and stored in the step of storing the still image is a compressed format, decompressing the image after the step of re-executing the preview, and
wherein the image processing in the step of decompressing the image does not affect the re-execution of the preview.

4. The method as claimed in claim 1, wherein the system further comprises a camera IC and has a mode wherein the camera IC directly controls the display unit, and
the image stored in the step of storing the still image is stored in a system storage unit, wherein the stored image has the same resolution as that of the image outputted from the image output means.

5. The method as claimed in claim 1, wherein the system further comprises a camera IC and has a mode wherein the camera IC directly controls the display unit, and
wherein the method further comprises the step of inputting a desired Crop & Resize condition, after the step of pausing the preview, and then issuing a capture command,
wherein a corresponding image suitable for the Crop & Resize condition is stored in an image buffer region of the camera IC, and
wherein in the step of storing the image, the image stored in the image buffer region of the camera IC depending on the Crop & Resize condition is copied and re-stored in the system storage unit, so that an image of a resolution higher than the preview image is captured.

6. The method as claimed in claim 1, wherein the system has a mode wherein the control operation unit directly controls the display unit, and
in the step of storing the still image, the still image experiences a Crop & Resize process in a predetermined format and is then copied and stored in other region of the system storage unit, in the system storage unit in which the output image of the display unit is stored.

7. A method for capturing a still image in real time in a system having an image capture means, a display unit, an image storage unit and an image processing unit, wherein an external image captured by the image capture means is previewed on the display unit and a predetermined still image of a preview image is captured in real time in order to process the image, the method comprising the steps of:
inhibiting a write into an image buffer region of the image storage unit;
subjecting the image stored in the image buffer region to a Crop and Resize process and copying the processed image to other region of the image storage unit; and
permitting a write into the image buffer region of the image storage unit, wherein in a state where an image preview updated through the image capture means is continuously activated, a real-time still image is captured by controllably activating and inactivating the write of the still image into the image buffer region.

8. The method as claimed in claim 7, further comprising the step of, if the format of the image that is captured in the step of copying the image stored in the image buffer region is a compressed format, decompressing the copied image of the compressed format after the step of permitting the write into the image buffer region.

9. A method for providing services using a code image, comprising:
capturing a code image using the method for capturing the still image in real time according to any one of claims 1 to 8;
allowing the image processing unit to decode the code image captured through the code image capture step and to extract a code value;
if the code value contained in the code image captured through the decoding step is extracted, allowing a browser of the system to call URL associated with the code value to a host server associated with the system; and
allowing the host server to search URL or contents corresponding to the code value, to send the searched result to the system, and then to receive related services from the system.

10. The method as claimed in claim 9, wherein in the step of decoding the code, additional factors including the type of the code captured in the system are decoded with them added to the code.
